(19) United States
(12) Patent Application Publication
(10) Pub. No.: US 2009/0098404 A1
(43) Pub. Date: Apr. 16, 2009

(54) SYSTEM FOR FORMING HOLES IN METAL SHEET

(75) Inventor: Shohei Matsuyama, Wako-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/251,697

(22) Filed: Oct. 15, 2008

(30) Foreign Application Priority Data
Oct. 16, 2007 (JP) 2007269315
Oct. 18, 2007 (JP) 2007-271838
Oct. 24, 2007 (JP) 2007-276531
Oct. 25, 2007 (JP) 2007-277990
Oct. 29, 2007 (JP) 2007-280058

(51) Int. Cl. B32B 3/10; B23P 15/00; B32B 15/00; G01N 3/00

(52) U.S. Cl. 428/596; 29/896.6; 73/788

(57) ABSTRACT

A perforated sheet obtained by forming holes in regular order in a metal sheet, the perforated sheet having holes arranged so that in a case of drawing a first tangential line extending in the tensile direction and passing through the bottom edge of a (1-1) hole, a second tangential line passing through the top edge of a (2-1) hole, a third tangential line passing through the bottom edge of the (2-1) hole, and a fourth tangential line passing through the top edge of a (1-2) hole, the second tangential line passes between the first tangential line and the fourth tangential line, and the third tangential line passes between the first tangential line and the fourth tangential line.

### FIELD OF THE INVENTION

The present invention relates to a system for forming round or oblong holes in a metal sheet.

### BACKGROUND OF THE INVENTION

With the demand for weight reduction in vehicle bodies, it has become possible to use a perforated sheet in part of a vehicle body, as shown in Japanese Patent Application Laid-Open Publication No. 2004-82796 (JP 2004-082796 A), for example. The perforated sheet is described with reference to FIG. 41 hereof.

As shown in FIG. 41, a vehicle hood 100 is composed of a hood outer panel 101, and a hood inner panel 102 superposed over the hood outer panel 101. The hood inner panel 102 is a perforated sheet wherein holes 103 are formed in regular order in a metal sheet.

Since the hood inner panel 102 is made more lightweight in proportion to the large number of holes 103, weight reduction in the hood 100 can be achieved.

When the hood 100 is subjected to tension, the hood 100 stretches. The stretching improves the capacity to absorb collision energy. Therefore, a perforated sheet that stretches readily is suitable as a vehicle structural member.

However, when the tensile force becomes excessive, cracks form between a hole 103 and an adjacent hole 103. Therefore, stretching is restricted in the perforated sheet. In cases in which the perforated sheet is a reinforcing member for the vehicle body, tensile strength, flexural strength, and other mechanical characteristics are required.

In view of this, there is a demand for a perforated sheet in which a reduced weight can be maintained, and in which stretching, tensile strength, and flexural strength can be ensured.

Furthermore, if the perforated sheet is a structural member of a vehicle, the perforated sheet is subjected to plastic working by means of pressing. In this case, a working method is needed wherein cracks do not form between the holes.

When an attempt is made to use calculations to determine the mechanical characteristics of a perforated sheet obtained by forming holes in a metal sheet, the calculations become complicated. This is because the metal sheet must be segmented into elements having dimensions smaller than the hole diameters. There is a demand for a simpler calculation method for this type of perforated sheet.

### SUMMARY OF THE INVENTION

According to a first aspect of the present invention, there is provided a perforated sheet obtained by forming holes in regular order in a metal sheet, wherein hole groups in even-numbered rows are arranged misaligned from hole groups in odd-numbered rows by a pitch of 0.5 in the direction of the rows, and tension is applied through external force in a direction orthogonal to the rows; a (1-1) hole which is the first hole in the first hole group, a (1-2) hole which is the next hole after the (1-1) hole, and a (2-1) hole which is the first hole of the second hole group are disposed at the apexes of a triangle; a tangential line that extends in the tensile direction while being tangent to the top edge of the (2-1) hole either passes between a tangential line that extends in the tensile direction while being tangent to the bottom edge of the (1-1) hole and a tangential line that extends in the tensile direction while being tangent to the top edge of the (1-2) hole, or passes above the tangential line that extends in the tensile direction while being tangent to the bottom edge of the (1-1) hole; and a tangential line that extends in the tensile direction while being tangent to the bottom edge of the (2-1) hole either passes between a tangential line that extends in the tensile direction while being tangent to the bottom edge of the (1-1) hole and a tangential line that extends in the tensile direction while being tangent to the top edge of the (1-2) hole, or passes above a tangential line that extends in the tensile direction while being tangent to the top edge of the (1-2) hole.

No holes are provided between the first tangential line and the second tangential line. Nor are any holes provided between the third tangential line and the fourth tangential line. It has been confirmed as a result of testing that the perforated sheet of the present invention has far greater ductility than a conventional perforated sheet in which holes are provided between the first tangential line and the second tangential line as well as between the third tangential line and the fourth tangential line.

According to a second aspect of the present invention, there is provided a perforated sheet obtained by forming holes in regular order in a metal sheet subjected to tension in the longitudinal direction, wherein the holes are oblong holes extending in the longitudinal direction.

The rigidity increases with increased minimum distance between the edge of a hole and the edge of an adjacent hole. If the pitch is the same, the minimum distance between the edge of an oblong hole extending in the longitudinal direction and the edge of an adjacent oblong hole is greater than the minimum distance between the edge of a round hole and the edge of an adjacent round hole, and ductility can therefore be increased according to the present invention.

Preferably, the oblong holes have a major axis 2.0 to 5.0 times the minor axis in length.

It is desirable that the perforated sheet be comprised of a flat sheet part provided with the oblong holes, and wall parts that extend downward from the ends of the flat sheet part and do not have oblong holes, the perforated sheet having the shape of a channel.

According to a third aspect of the present invention, there is provided a method for selecting a hole shape for a perforated sheet obtained by forming oblong holes or round holes in regular order in a metal sheet; wherein in cases in which flexural rigidity is required and the acting direction of the force for bending the metal sheet can be designated, oblong holes are selected as the holes, and the oblong holes extend along lines whereby the fulcra that support the metal sheet are joined with the load point of action of the bending force; in cases in which tensile strength is required and the direction in which the tension acts on the metal sheet can be designated, oblong holes are selected as the holes, and the oblong holes are extended along the tensile direction and arranged at the points of intersection in a lattice; and in cases in which tensile strength is required and the direction in which the tension acts on the metal sheet cannot be designated, round holes are selected as the holes, and the round holes are arranged at the points of intersection of a lattice.

Oblong holes are selected when the tensile direction is specified, and round holes are selected when the tensile direction is not specified. The hole selection can be easily made. As a result of testing, it is possible to increase tensile strength by arranging the oblong holes or round holes at the points of intersection of a lattice.

According to a fourth aspect of the present invention, there is provided a perforated sheet working method for punching a mild steel blank material and then drawing the resulting perforated sheet, the perforated sheet working method comprising the steps of: setting drawing height conditions within a range that does not exceed 50% of the drawing height limit of the mild steel blank material; setting, as shape conditions, the limit of the extent of bending, the limit of the angle of the inclined surface, and other limit conditions taken into account when drawing a high-tensile steel sheet; and performing drawing on the basis of the shape conditions and the drawing height conditions.

The plastic working conditions of a mild steel blank material and a high-tensile steel sheet in which no holes have been made can be easily established. The plastic working conditions of the perforated sheet are established based on these easily established plastic working conditions. The result is that the conditions to work the perforated sheet can be easily established, and plastic working can be performed quickly.

According to a fifth aspect of the present invention, there is provided a method for estimating the mechanical characteristics of a perforated sheet partitioned into hole formation areas in which holes are formed in regular order, and a remaining area in which holes are not formed, wherein there is a plurality of hole formation areas, and the hole formation areas have rectangular shapes; the method for estimating the mechanical characteristics of a perforated sheet comprising the steps of: creating a test piece having the same shape as the hole formation areas; obtaining actual measurement values related to mechanical characteristics by performing tests on the test piece; obtaining calculated values related to mechanical characteristics by performing calculations on the test piece; obtaining specialized calculated values related to mechanical characteristics by performing calculations on the hole formation areas upon confirmation that the difference between the actual measurement values and the calculated values is less than a specified value; assembling solid areas, which are obtained by not making any holes in the usual hole formation areas, on the remaining area; and applying the specialized calculated values to the solid areas in the resulting assembly, so as to enable calculations for the strength of the perforated sheet with the assembly in which holes are not formed.

The calculation time increases when an attempt is made to determine the mechanical characteristics of the perforated sheet through calculation. The mechanical characteristics of a member that does not have any holes, on the other hand, can be easily found through calculation.

In a perforated sheet composed of hole formation areas and a remaining area in which holes are not formed, the hole formation areas are replaced by solid areas having low rigidity, for example. The mechanical characteristics are calculated after the manner of a perforated sheet composed of solid areas of low rigidity and a remaining area. In other words, according to the present invention, the mechanical characteristics of a perforated sheet can be determined in a short amount of calculation time.

It is preferred that when the difference between the actual measurement values and the calculated values is equal to or greater than a specified value, a correction value is determined based on the difference, and the calculated values are corrected using the correction value.

### BRIEF DESCRIPTION OF THE DRAWINGS

Certain preferred embodiments of the present invention will be described in detail below, by way of example only, with reference to the accompanying drawings, in which:

FIG. 1 is a view of a first model;

FIG. 2 is an enlarged view of area 2 of FIG. 1;

FIG. 3 is a view showing a tensile force being applied to the first model;

FIG. 4 is a view as seen in the direction of arrow 4 of FIG. 3;

FIG. 5 is a diagrammatical view showing a correlation between λ and σ in the first model;

FIG. 6 is a view of a second model;

FIG. 7 is an enlarged view of area 7 of FIG. 6;

FIG. 8 is a view showing a tensile force being applied to the second model;

FIG. 9 is a view as seen in the direction of arrow 9 of FIG. 8;

FIG. 10 is a diagrammatical view showing a correlation between λ and σ in the second model;

FIG. 11 is a diagrammatical view combining FIGS. 5 and 10;

FIG. 12A is a diagrammatical view showing the shape of oblong holes;

FIG. 12B is a diagrammatical view showing the shape of round holes;

FIG. 13A is a perspective view of a third model;

FIG. 13B is a perspective view of a fourth model;

FIG. 14 is a view showing a summary of a flexing test;

FIG. 15 is a graph showing the rigidity of the third and fourth models;

FIG. 16 is a view of a fifth model;

FIG. 17 is a view of a sixth model;

FIG. 18 is a partial view showing on an enlarged scale part of the sixth model;

FIG. 19 is a view of a seventh model;

FIG. 20 is a view of an eighth model;

FIG. 21 is a partial view showing on an enlarged scale part of the eighth model;

FIG. 22 is a view of a ninth model;

FIG. 23 is a view showing a summary of a flexing test;

FIG. 24 is a diagrammatical view showing the flexure of the fifth through ninth models;

FIG. 25 is a view showing a summary of a tensile test;

FIG. 26 is a diagrammatical view showing the displacement of the fifth through ninth models;

FIG. 27 is a view of a tenth model;

FIG. 28 is a view of an eleventh model;

FIG. 29 is a diagrammatical view showing displacement in the fifth through seventh and the tenth through eleventh models;

FIG. 30 is a schematic view showing the principle of a press machine;

FIG. 31A is a view showing a blank material subjected to pressing;

FIG. 31B is a view showing a perforated sheet subjected to pressing;

FIG. 32 is a schematic view showing an operation of the press machine;

FIG. 33 is a graph showing drawing height levels obtained with a hemispherical punch;

FIG. 34 is a graph showing drawing height levels obtained with a truncated conical punch;

FIG. 35 is a graph showing a strain-stress;

FIG. 36 is a view of a twelfth model;

FIG. 37 is a view of a test piece;

FIG. 38 is a schematic view showing a common static testing method;

FIG. 39 is a schematic view showing the static testing method performed on a test piece;

FIG. 40 is a view of an assembly; and

FIG. 41 is a schematic view showing the arrangement of a conventional perforated sheet.

### DETAILED DESCRIPTION OF THE PREFERRED EMBODIMENTS

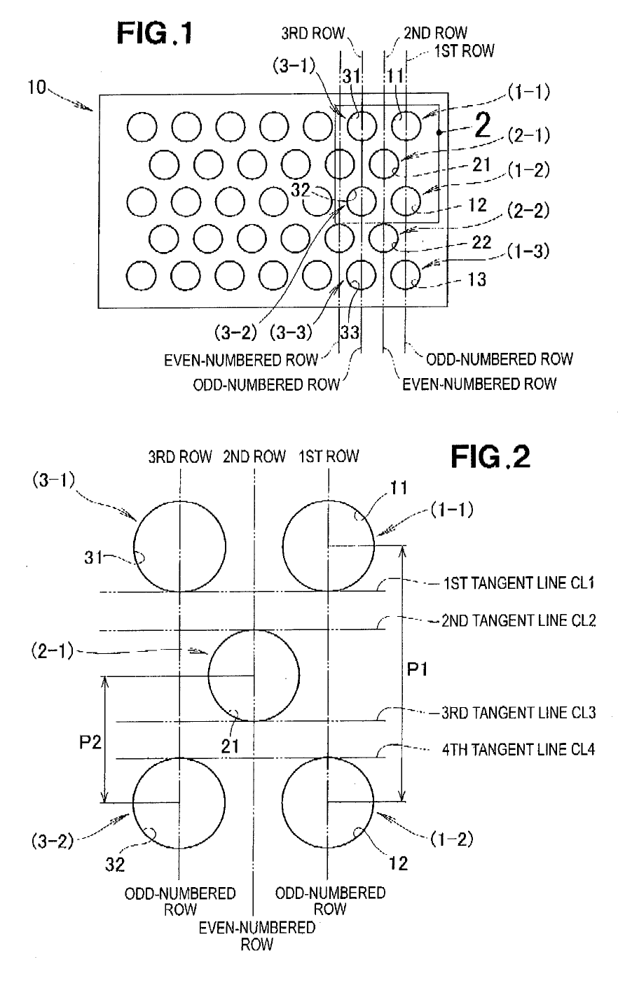

A first model 10 shown in FIG. 1 is a perforated sheet in which holes 11, 12, 13, 21, 22, 31, 32, 33 are formed in regular order by punching or another method in a metal sheet. The first model 10 is stretched parallel to the transverse sides.

A line passing through the centers of the holes 11, 12, 13 is drawn parallel to the longitudinal sides of the model 10, and the group of holes disposed along this line is referred to as a row.

Furthermore, progressing from the right side of the drawing, the rows are referred to as the first row, the second row, and the third row; the holes progressing down from the first hole at the top of the first row are denoted in sequence as (1-1) hole 11, (1-2) hole 12, and (1-3) hole 13; the holes progressing downward from the first hole at the top of the second row are denoted in sequence as (2-1) hole 21 and (2-2) hole 22; and the holes progressing downward from the first hole at the top of the third row are denoted in sequence as (3-1) holes 31, (3-2) hole 32, and (3-3) hole 33.

The rows disposed in odd numbers from the right such as the first row, the third row, and the like are odd-numbered rows, and the rows disposed in even numbers from the right such as the second row are even-numbered rows.

The pitch between (1-1) hole 11 and (1-2) hole 12 is P1, and the pitch between (2-1) hole 21 and (3-2) hole 32 is P2, as shown in FIG. 2. (2-1) Hole 21 is disposed so that P2 is half of P1.

Specifically, groups of holes in even-numbered rows are provided at a 0.5 pitch misalignment from the groups of holes in odd-numbered rows.

It is possible to draw a first tangential line CL1 extending in the tensile direction and passing through the bottom edge of (1-1) hole 11, a second tangential line CL2 passing through the top edge of (2-1) hole 21, a third tangential line CL3 passing through the bottom edge of (2-1) hole 21, and a fourth tangential line CL4 passing through the top edge of (1-2) hole 12, in which case the holes 11, 12, 21, 31, 32 are disposed so that the second tangential line CL2 passes between the first tangential line CL1 and the fourth tangential line CL4, and the third tangential line CL3 passes between the first tangential line CL1 and the fourth tangential line CL4.

Another possibility is to have the second tangential line CL2 overlap the first tangential line CL1, and to have the third tangential line CL3 overlap the fourth tangential line CL4.

The first model 10 described above is subjected to a tensile test. A summary thereof will next be described.

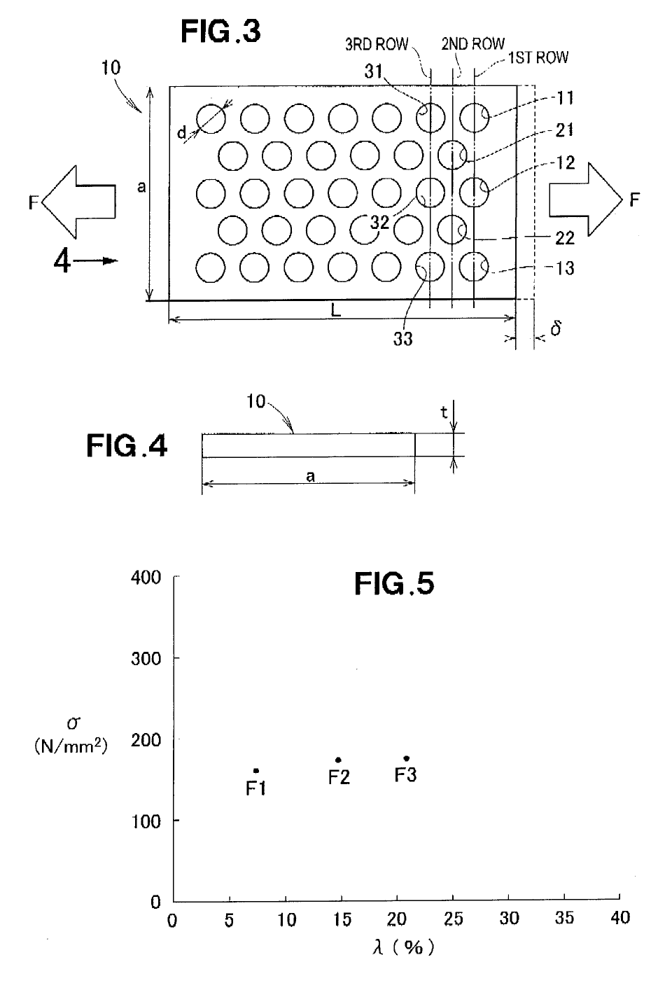

The first model 10 is a hot-rolled steel sheet (JIS G 0203) having a width of a and a length of L, in which holes are provided with a hole diameter d of 3 mm and an aperture ratio of 32%, as shown in FIG. 3. The aperture ratio is defined as (Aperture surface area/Surface area of metal sheet)×100.

This first model 10 is pulled at a force of F, as shown by the arrows, until a perforated sheet 10 is severed. The stretching δ shown by the dashed line at this time is measured. The stretching rate λ can be calculated from the measured stretching δ, through the mathematical formula λ=(δ/b)×100 (%).

If the first model 10 has a thickness of t as shown in FIG. 4, the cross-sectional area is a×t. The tensile stress σ is calculated by the formula σ=F/(a×t) (N/mm²).

The tensile force F is progressively increased in the sequence of F1, F2, F3, and the stretching rate λ and tensile stress σ at F1 are measured. Similarly, the stretching rate λ and tensile stress σ at F2 and F3 are measured. The perforated sheet severs immediately after F3.

The relationship between the tensile forces F1, F2, F3, the stretching rate λ, and the tensile stress σ is shown in the graph in FIG. 5. The stretching rate λ and the tensile stress σ increase in proportion to the tensile force F.

Next, to compare with the first model 10, a second model 30 is set, and the stretching rate λ and tensile stress σ of the second model 30 are determined by testing.

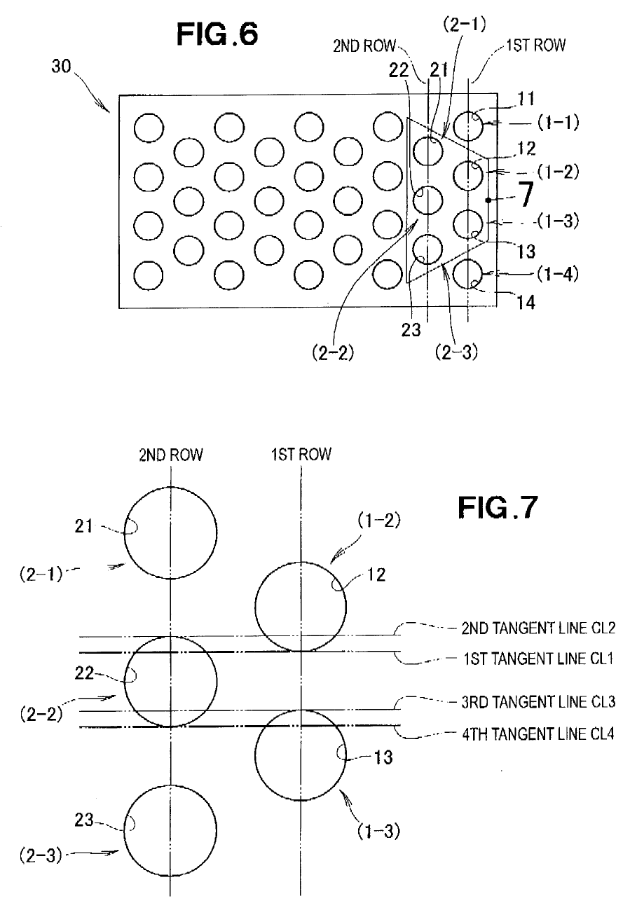

Holes 11, 12, 13, 14, 21, 22, 23 are provided in the second model 30 by punching or another method in a metal sheet as shown in FIG. 6.

A line passing through the center of hole 11 is drawn parallel to the longitudinal sides, and the group of holes disposed along this line are referred to as a row. The rows include the first row and second row, starting from the right side; the holes starting at the first hole at the top of the first row downward are referred to in sequence as (1-1) hole 11, (1-2) hole 12, (1-3) hole 13, and (1-4) hole 14 starting at the first hole at the top of the second row downward are referred to in sequence as (2-1) hole 21, (2-2) hole 22, and (2-3) hole 23.

It is possible to draw a first tangential line CL1 extending in the tensile direction and passing through the bottom edge of (1-2) hole 12, a second tangential line CL2 passing through the top edge of (2-2) hole 22, a third tangential line CL3 passing through the bottom edge of (2-2) hole 22, and a fourth tangential line CL4 passing through the top edge of (1-3) hole 13, in which case the second tangential line CL2 passes above the first tangential line CL1, and the fourth tangential line CL4 passes below the third tangential line CL3, as shown in FIG. 7.

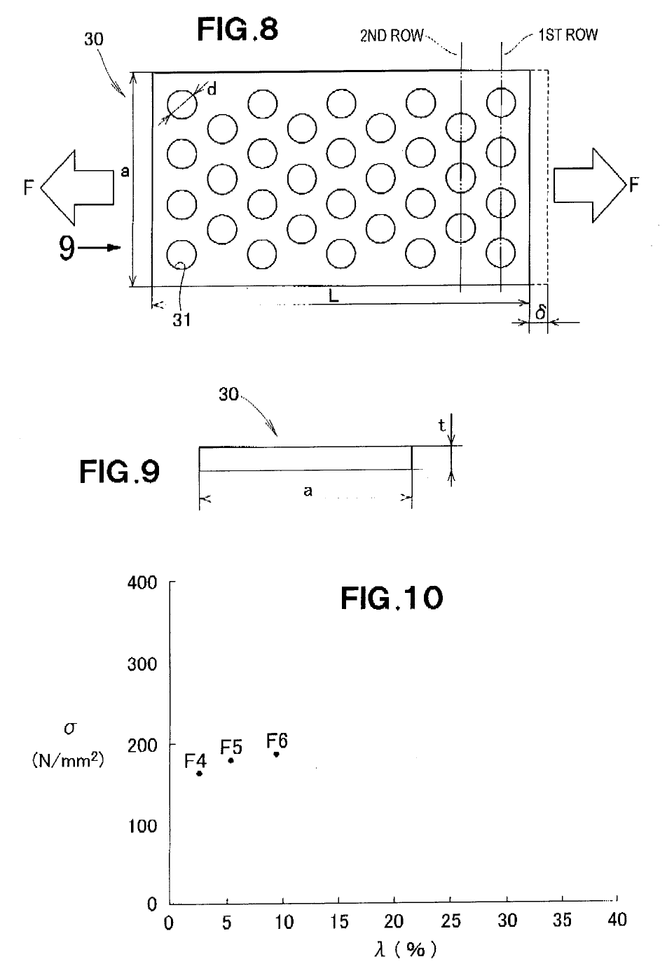

Next, the second model 30 is a hot-rolled steel sheet (JIS G 203) having a width of a and a length of L, in which holes are provided with a hole diameter d of 3 mm and an aperture ratio of 32%, as shown in FIG. 8.

This second model 30 is pulled at a force of F as shown by the arrows until a perforated sheet 30 is severed, the stretching δ is measured, and the stretching rate λ is calculated.

The tensile stress σ is calculated with respect to the cross-sectional area a×t according to the formula σ=F/(a×t) (N/mm²), as shown in FIG. 9.

The tensile force F is progressively increased in the sequence of F4, F5, F6, and the stretching rate λ and tensile stress σ at F4 are measured. Similarly, the stretching rate λ and tensile stress σ at F5 and F6 are measured. The second model 30 severs immediately after F6.

The relationship between the tensile forces F4, F5, F6, the stretching rate λ, and the tensile stress σ is shown in the graph in FIG. 10. The stretching rate λ and the tensile stress σ increase in proportion to the tensile force F.

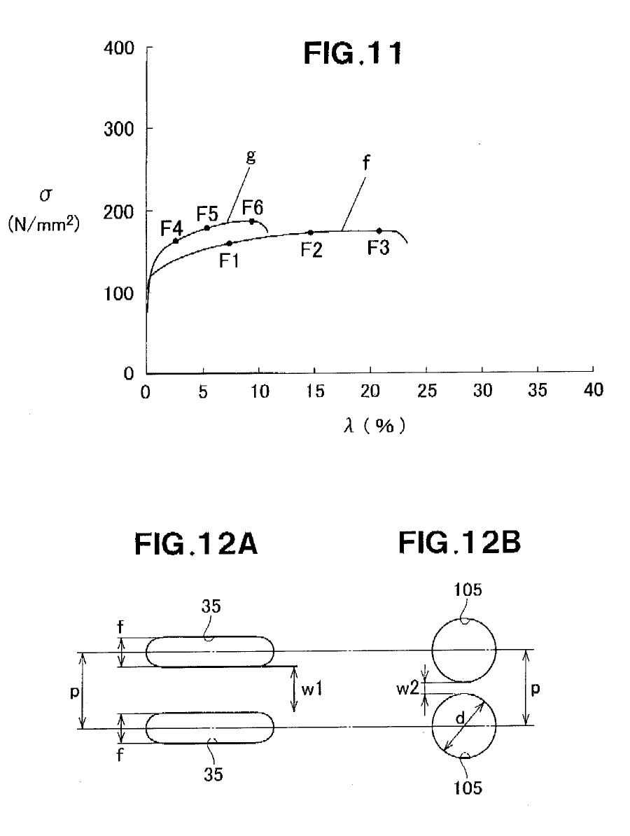

A superposition of F4 through F6 shown in FIG. 10 with F1 through F3 shown in FIG. 5 is shown in FIG. 11. Specifically, line g is shown below line f The stretching at F6 is approximately 9%, and the stretching at F3 is approximately 21%.

When line f and line g are compared, it can be seen that the first model 10 shown by line f stretched by approximately twice the amount of the second model 30 shown in line g until severing occurred.

Specifically, even if the perforated sheet has the same aperture ratio, longitudinal and transverse dimensions, and thickness, the first model 10 of the present invention, which takes the hole arrangement into account, can be stretched by twice the amount of the conventional second model 30, and the first model 10 is suitable as an energy-absorbing material, for example.

Next, round holes and oblong holes will be described.

The pitch between two oblong holes 35, 35 is p (the pitch in the direction orthogonal to the longitudinal direction), and the minimum distance between the edge of one oblong hole 35 and the edge of the adjacent oblong hole 35 is w1, as shown in FIG. 12A. The parameter w1 can be calculated by w1=(p−f).

Next, the round holes 105 shown in FIG. 12B are round holes (diameter d) of the same surface area as the oblong holes 35. The pitch between two round holes 105, 105 is p, and the minimum distance between the edge of one round hole 105 and the edge of the adjacent round hole 105 is w2. The parameter w2 can be calculated as w2=(p−d).

In cases in which tensile force is applied to the left or right of the drawing, w1 or w2 contributes to rigidity, and the greater w1 or w2, the less the tensile stress.

Since f<d, then w1>w2, and the oblong holes 35 have remarkably greater strength and rigidity than the round holes 105.

Next, comparative testing was performed in order to ascertain the effectiveness of the oblong holes 35.

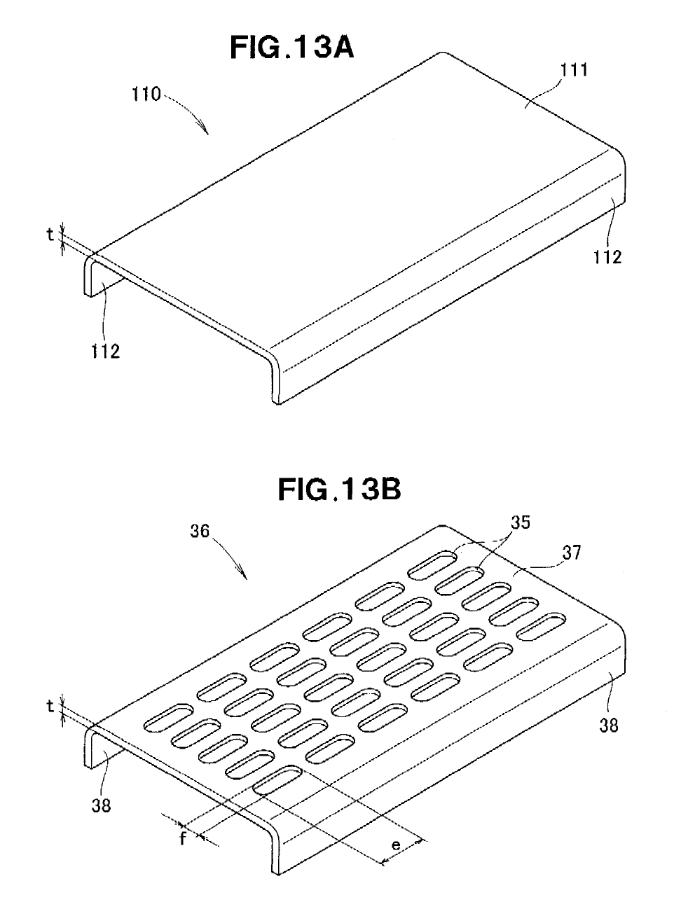

First, a third model 110 shown in FIG. 13A was prepared. The third model 110 is composed of a flat sheet part 111 having the shape of a rectangular sheet, and wall parts 112, 112 extending down from the ends of the flat sheet part 111. The flat sheet part 111 and the wall parts 112 all have a thickness of t.

Next, a fourth model 36 shown in FIG. 13B was prepared. The fourth model 36 is composed of a flat sheet part 37 having the shape of a rectangular sheet, wall parts 38, 38 extending down from the ends of the flat sheet part 37, and oblong holes 35 formed in the flat sheet part 37 and extending along the longitudinal direction, wherein the model has the same dimensions as the third model 110 except for the oblong holes 35.

The oblong holes 35 are preferably set so that if the major axes in the tensile direction are e and the minor axes in the cross direction are f, the ratio of major axis e and minor axis f is within a range of 2.0 to 5.0. In the fourth model 36 used in the testing, the ratio of major axis e minor axis f was 3.0.

A summary of the bending test performed on the third model 110 and the fourth model 36 will next be described.

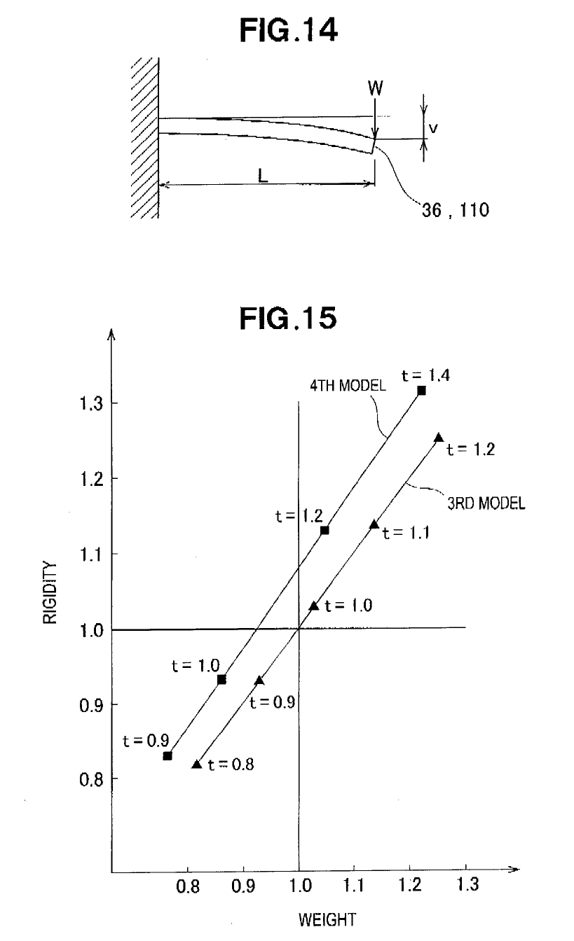

When the third model 110 or the fourth model 36, both having a length of L, was fixed in place at one end and a downward load of W was applied to the other end, the model flexed by an amount v, as shown in FIG. 14. Is known in structural mechanics that the following equality is satisfied under these conditions: v=W×L³/(3EI), where E is Young's modulus, and I is the geometrical moment of inertia.

A modification of this formula is I=W×L³/(3E v). Specifically, it is possible to determine I, which is an indicator of rigidity, by determining the flexure v through testing.

The thickness t of the third model 110 was varied at 0.8 mm, 0.9 mm, 1.0 mm, 1.1 mm, and 1.2 mm; the weights of the models were measured; and the rigidity I was determined by calculating from the resulting flexure v. The resulting rigidity is denoted by the symbol ▴ in FIG. 15. A directly proportional relationship between weight and rigidity was confirmed to exist in the third model 110, as shown in FIG. 15.

Next, the thickness t of the fourth model 36 was varied at 0.9 mm, 1.0 mm, 1.2 mm and 1.4 mm; the weights of the models were measured; and the rigidity I was determined by calculation from the resulting flexure v. The resulting rigidity is denoted by the symbol ▪ in FIG. 15. A directly proportional relationship between weight and rigidity was confirmed in the fourth model 36 as well, as shown in FIG. 15.

In this diagram, results obtained by setting an arbitrary weight of the fourth model 36 to 1.0, and the corresponding rigidity to 1.0 are expressed as a ratio. Varying the weight causes only the thickness t to vary, and other conditions including the material, the size in the longitudinal direction, the transverse width, the height of the wall parts, the shapes of the oblong holes, and the like remain the same.

The rigidity of the fourth model and the third model of the same weight is such that the fourth model has superior rigidity to the third model. Specifically, when the rigidity of the comparative example is 1.0 at the arbitrary weight of 1.0, the rigidity of the fourth model is approximately 1.08, and the rigidity is improved by approximately 8%.

The weights of the fourth model and the third model having the same rigidity are such that the weight of the fourth model is smaller. Specifically, when the weight of the third model is 1.0 at an arbitrary rigidity of 1.0, the weight of the fourth model is approximately 0.92, which is a weight reduction of approximately 8%. The corresponding sheet thickness t is greater in the fourth model.

Specifically, according to the present invention, the weight of a perforated sheet can be reduced while maintaining the required rigidity.

The ratio of the major and minor axes of the oblong holes in the example was 3.0, but the ratio of the major and minor axes may also be an arbitrary value such as 2.0 or 5.0, and the oblong holes may also have a non-systematic arrangement rather than being aligned in the longitudinal direction or transverse width direction.

The following is a description of the method of selecting the type of holes for a perforated sheet in which oblong holes or round holes are formed in a systematic pattern in a metal sheet.

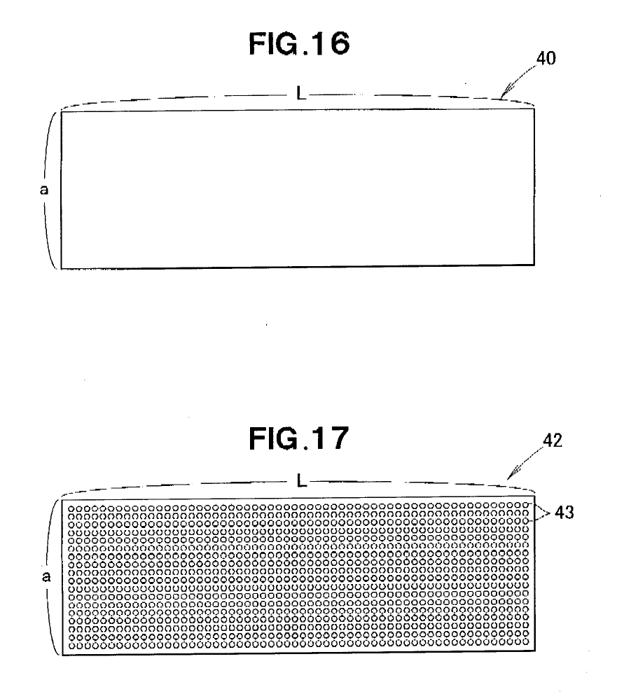

A fifth model 40 shown in FIG. 16 was prepared. The fifth model 40 is a metal sheet having a width a of 96 mm, a length L of 300 mm, and a thickness of t. The fifth model 40 was prepared for comparative purposes.

A sixth model 42 shown in FIG. 17 was prepared. The sixth model 42 is a perforated sheet having a width a of 96 mm, a length L of 300 mm, and a thickness of t.

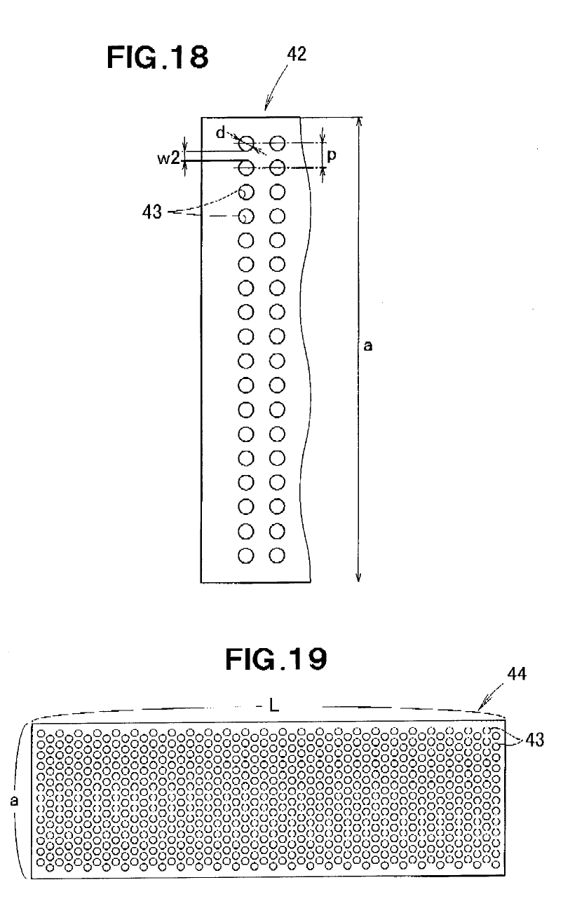

In the sixth model 42, round holes 43 having a diameter d of 3 mm are provided at the points of intersection of a lattice as shown in FIG. 18. The pitch is p, and w2 is the minimum distance between the edge of one round hole 43 and the edge of an adjacent round hole 43.

The weight of the fifth model 40 is assumed to be W1, and the weight of the sixth model 42 is assumed to be W2. W2 is less than W1 by an amount proportionate to the openings in the holes. The reduced weight is (W1−W2), and the greater this weight in comparison with the original weight W1, the greater the weight reduction. In view of this, the weight reduction ratio is defined as (W1−W2)/W1.

The weight reduction ratio of the sixth model 42 was set at approximately 28%.

A seventh model 44 shown in FIG. 19 was prepared. The seventh model 44 is a perforated sheet having a width a of 96 mm, a length L of 300 mm, and a thickness of t. Holes 43 having a diameter of 3 mm are arranged in a staggered pattern in the perforated sheet.

The weight reduction ratio of the seventh model 44 was set at approximately 28%.

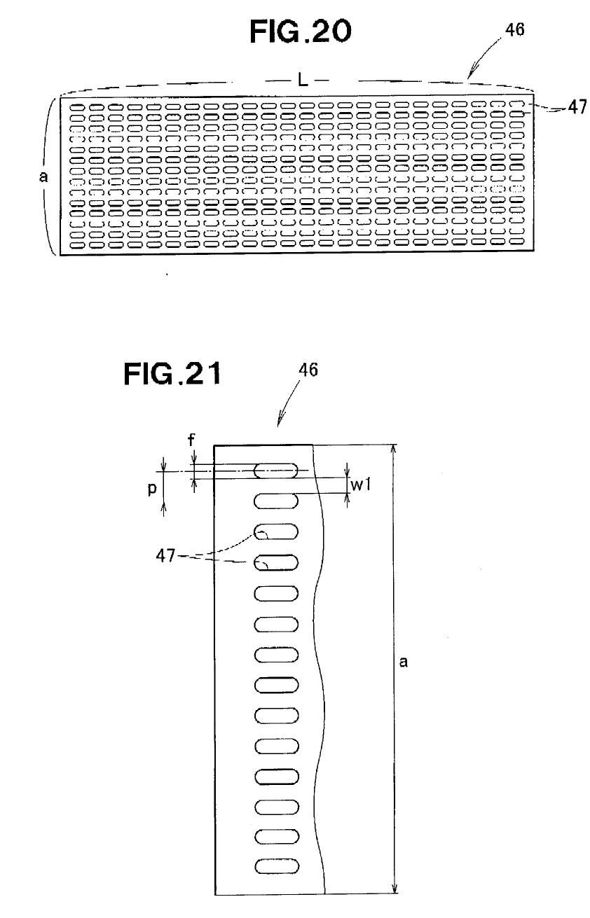

An eighth model 46 shown in FIG. 20 was prepared. The eighth model 46 is a perforated sheet having a width a of 96 mm, a length L of 300 mm, and a thickness of t.

In the eighth model 46, oblong holes 47 having a major axis of 9 mm and a minor axis of 3 mm are provided at the points of intersection of a lattice as shown in FIG. 21. The oblong holes 47 extend in the longitudinal direction. The pitch is p, and w1 is the minimum distance between the edge of one oblong hole 47 and the edge of an adjacent oblong hole 47.

The weight reduction ratio of the eighth model 46 was set at approximately 28%.

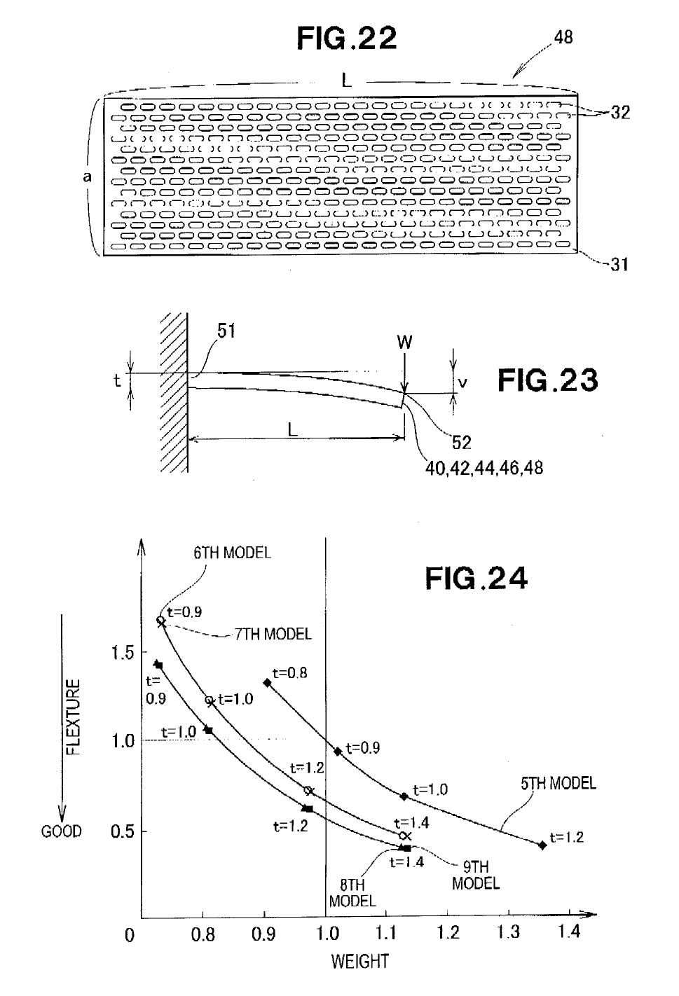

A ninth model 48 shown in FIG. 22 was prepared. The ninth model 48 is a perforated sheet having a width a of 96 mm, a length L of 300 mm, and a thickness of t. Oblong holes 47 having a major axis of 9 mm and a minor axis of 3 mm are arranged in a staggered pattern in the perforated sheet. The oblong holes 47 extend in the longitudinal direction.

The weight reduction ratio of the ninth model 48 was set to approximately 28%.

The fifth model 40 through the ninth model 48 described above were subjected to bending tests while being varied in thickness t.

The fifth model 40 through the ninth model 48, each having a length of L, were fixed in place at one end to a fixing fulcrum 51, a downward load W was applied to the other end 52, and the distal end was flexed by an amount v. It is known in structural mechanics that the following equality is satisfied under these conditions: v=W×L³/(3EI), where E is Young's modulus, and I is the geometrical moment of inertia.

A modification of this formula is I=W×L³/(3E v). Specifically, it is possible to determine I, which is an indicator of rigidity, by determining the flexure v through testing.

The results are shown in FIG. 24.

In the fifth model, upon measuring flexure at a length L of 300 mm and a thickness t of 0.8 mm, 0.9 mm, 1.0 mm, and 1.2 mm, it was found that the weight (empty weight) increased when the thickness t increased, as shown in FIG. 24. Flexure decreased in proportion to weight.

The weight (empty weight) increased when the thickness t increased in the sixth model, the seventh model, the eighth model, and the ninth model as well. Flexure decreased in proportion to weight.

The curve of the seventh model overlapped the curve of the sixth model, and the curve of the ninth model overlapped the curve of the eighth model.

When the sixth model 42 shown in FIG. 18 and the eighth model 46 shown in FIG. 21 are compared, since the weight reduction ratios resulting from holes are set to be equal, there are fewer oblong holes 47, which have greater area than the round holes 43. Therefore, the pitch p of two oblong holes 47, 47 in the eighth model 46 is greater than the pitch p of two round holes 43, 43 in the sixth model 42. As a result, w1>w2, and when a tensile force acts on the left or right side of the drawing, the eighth model 46 has a markedly greater strength than the sixth model 42. When a downward bending force acts on the distal end, tensile force acts on the top surface of the perforated sheet, and compressive force acts on the bottom surface. Consequently, the eighth model 46 also has a markedly greater strength than the sixth model 42 under the action of a bending force.

This is substantiated by the fact that the eighth model and ninth model undergo less flexure than the sixth model and seventh model, as shown in FIG. 24. A small amount of flexure implies high flexural rigidity.

When a hole shape is selected for a perforated sheet obtained by forming oblong holes or round holes in regular order in a metal sheet, in cases in which flexural rigidity is required and the acting direction of the force for bending the metal sheet can be designated, oblong holes are selected as the holes, and the eight model or ninth model is recommended in which the oblong holes extend along lines whereby the fulcra that support the metal sheet are joined with the load point of action of the bending force.

Next, the fifth model 40 through the ninth model 48 were subjected to tensile tests while being varied in thickness t.

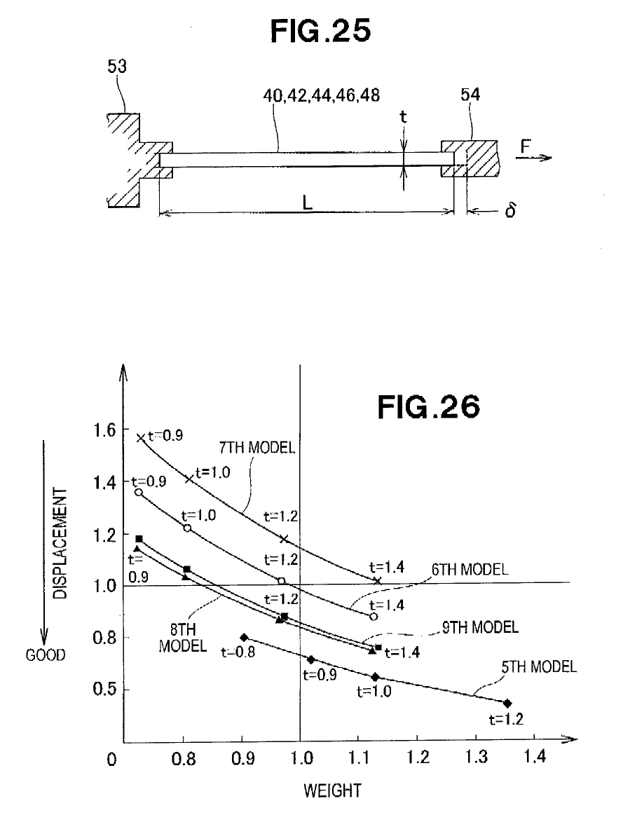

One end in each of the fifth model 40 through the ninth model 48 was held within a stationary clamp 53, and the other end was held within a moving clamp 54, as shown in FIG. 25. The moving clamp 54 was moved, and a tensile force of F was applied to the fifth model 40 through the ninth model 48. When the tensile force F was applied, the fifth model 40 through the ninth model 48 extended as a whole, and the other end was displaced by an amount δ. The results are shown in FIG. 26.

There was less displacement in the eighth model and ninth model provided with oblong holes extending in the tensile direction than in the sixth model and seventh model provided with round holes, and it was confirmed that tensile strength was greater, as shown in FIG. 26.

Furthermore, the eighth model had less displacement than the ninth model, and it was confirmed that tensile strength was greater. The oblong holes are arranged at the points of intersection of a lattice in the eighth model.

When a hole shape is selected for a perforated sheet obtained by forming oblong holes or round holes in regular order in a metal sheet, in cases in which tensile strength is required and the direction in which the tension acts on the metal sheet can be designated, oblong holes are selected as the holes, and it is recommended that these holes extend along the tensile direction and be arranged at the points of intersection in a lattice.

There are also cases in which the tensile direction in the perforated sheet cannot be designated. The sixth model 42 and the seventh model 44 have no difference in round hole alignment between the length L direction and the width a direction, and the tensile direction therefore has no effect.

The eighth model 46 and the ninth model 48 differ in the axes of the oblong holes between the length L direction and the width a direction, and the tensile direction therefore has a great effect.

In view of this, a tenth model 56 and an eleventh model 58, which are described below, were subjected to testing as models to replace the eighth model 46 and the ninth model 48.

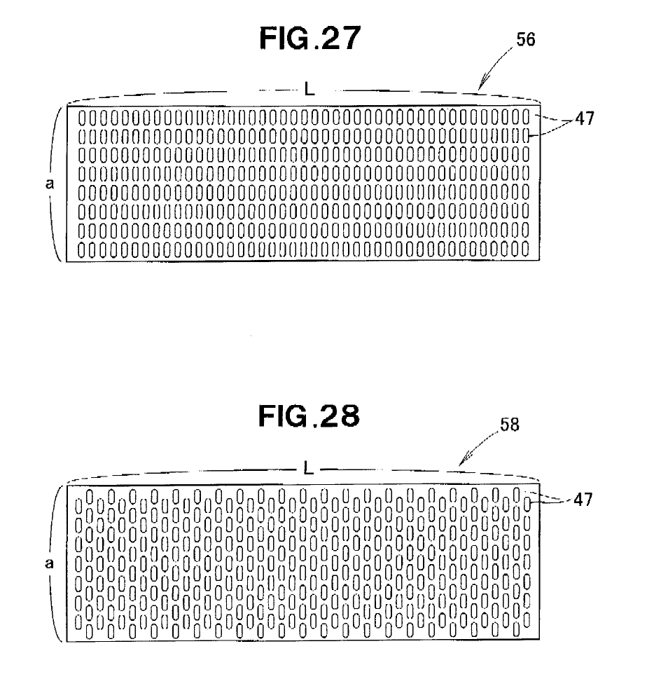

In the tenth model 56, oblong holes 47 extend along the width a direction, and the holes are aligned at the points of intersection of a lattice, as shown in FIG. 27.

In the eleventh model 58, oblong holes 47 extend along the width a direction, and the holes are aligned in a staggered pattern, as shown in FIG. 28.

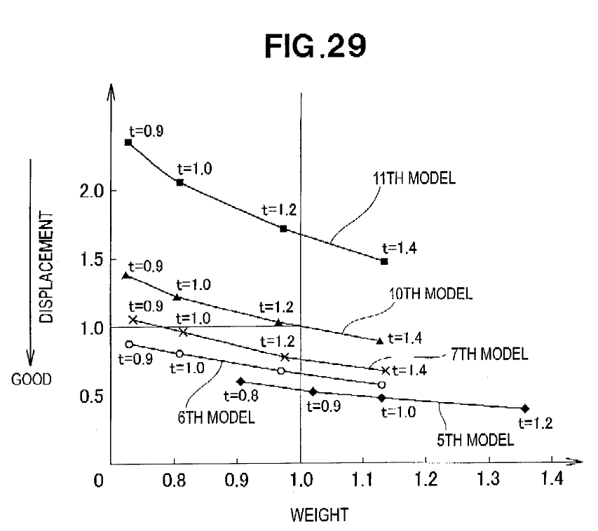

The tenth model 56 and eleventh model 58 described above were subjected to the same tensile test as the fifth through seventh models 40 through 44, and a summary of the test is shown in FIG. 25. The results are shown in FIG. 29.

The tenth model and the eleventh model had a large amount of displacement and low tensile strength, as shown in FIG. 29. It was confirmed that the sixth model and the seventh model had little displacement and high tensile strength. Furthermore, it was confirmed that the sixth model had less displacement and greater tensile strength than the seventh model. The sixth model is a perforated sheet in which round holes are aligned at the points of intersection of a lattice.

When a hole shape is selected for a perforated sheet obtained by forming oblong holes or round holes in regular order in a metal sheet, in cases in which tensile strength is required and the direction in which the tension acts on the metal sheet cannot be designated, round holes are selected as the holes, and it is recommended that these round holes be arranged at the points of intersection of a lattice.

Since a perforated sheet provided with the round holes or oblong holes described above is susceptible to cracking between holes, there are restrictions even on draw working. Therefore, it is much more difficult to establish the conditions to work a perforated sheet in comparison with a blank material having no holes.

In view of this, there is a demand for a technique whereby the conditions to work a perforated sheet can be easily established.

Through research and development, the inventors have noticed a constant correlative relationship between the conditions to work a perforated sheet and the conditions to work a blank material. There is an abundance of past data on the conditions to work blank materials, which can be established comparatively easily. It is believed that the conditions to work a perforated sheet can be easily established if the conditions to work the perforated sheet can be established based on the conditions to work a blank material.

In view of this, comparative testing was performed on perforated sheets and blank materials.

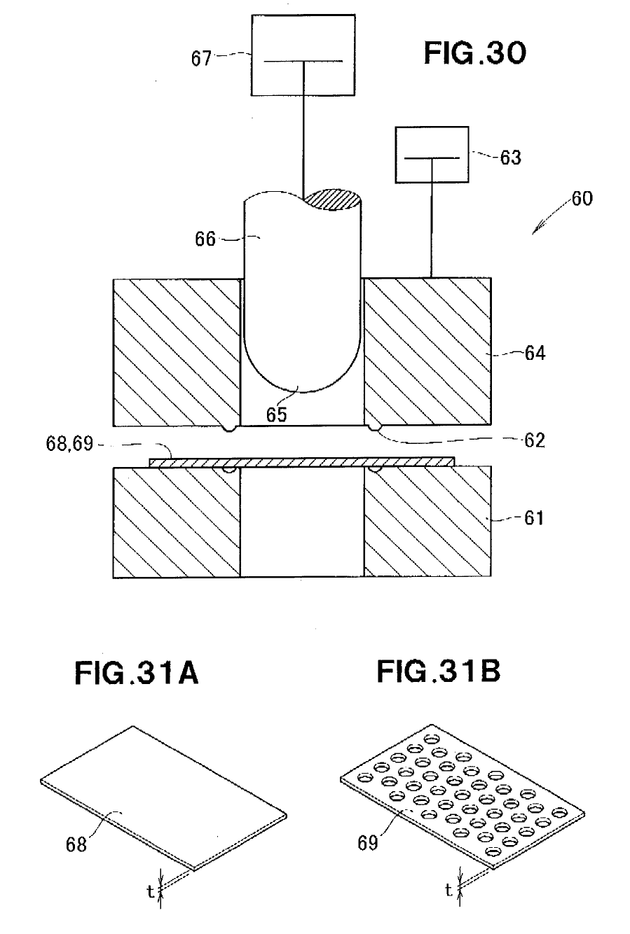

The test was performed with a press machine 60 shown in FIG. 30. The press machine 60 is composed of a lower die 61, an upper die 64 that comprises beads 62 on the bottom surface and that hangs from a first cylinder 63, a punch 66 that rises and falls through the upper die 64 and that comprises a hemispherical part 65 at the bottom end (distal end), and a second cylinder 67 that raises and lowers the punch 66.

For metal sheets subjected to the testing, a mild steel blank material 68 shown in FIG. 31A and a perforated sheet 69 shown in FIG. 31B were prepared.

The mild steel blank material 68 is specified by JIS G 3131, “Hot-rolled Mild Steel Sheets and Steel Strips.” SPHD or SPHE is suitable for draw working. SPH or SPHE is a mild steel material having a tensile strength of 270 N/mm² or greater. SPCC, SPCD, or SPCE specified in JIS G 3141, “Cold-reduced Carbon Steel Sheets and Steel Strips,” can be used as the mild steel blank material 68. SPCC, SPCD, or SPCE is also a steel material having a tensile strength of 270 N/mm² or greater.

A perforated sheet 69 is a sheet obtained by forming holes in a mild steel blank material.

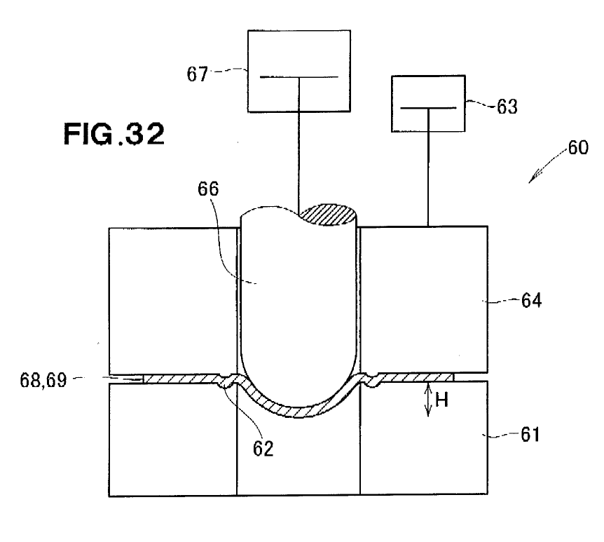

The mild steel blank material 68 is placed on the lower die 61 and is pressed by the upper die 64 as shown in FIG. 32. A pressure of several dozen tons to several hundred tons is applied by the action of the first cylinder 63. The beads 62 then push into the mild steel blank material 68. In this state, the punch 66 is slowly lowered by the action of the second cylinder 67. The mild steel blank material 68 begins to deform into a convexity at the bottom. When the punch 66 is lower to a certain level, the elongation of the mild steel blank material 68 cannot follow the deformation any longer, and the materials tears. The drawing height H at this time is a drawing height limit. If the drawing height H is set to be less than the drawing height limit, there is no need for concern over tearing.

The drawing height limit described above is determined by testing.

A testing example according to the present invention is described hereinbelow. The present invention is not limited to the testing example.

Design of press machine (common):
Diameter of punch: 150 mm
Shape of distal end of punch: hemispherical or conical
Diameter of upper die hole: 153 mm
Radius of bead provided to upper die: 10 mm
Axial force of first cylinder: 100 tons
Diameter of lower die hole: 160 mm
Lubricant: lubricating oil

Mild steel blank material:
Thickness: 1.0 mm
Material: JIS G 3131 SPHD
Number of samples: 6

Measuring drawing height:
The drawing height at the moment tearing occurred was set as the “maximum drawing height.” The maximum drawing height levels found for the six samples are shown in Table 1 below.

TABLE 1

| | | Thickness | | |
|---|---|---|---|---|
| | | of mild | Maximum | Average |
| Specimen no. | Shape of punch | steel sheet | drawing height | value |
| Specimen 1 | hemispherical | 1 mm | 47.5 mm | 46.96 mm |
| Specimen 2 | hemispherical | 1 mm | 46.9 mm | |
| Specimen 3 | hemispherical | 1 mm | 46.5 mm | |
| Specimen 4 | truncated cone | 1 mm | 26.7 mm | 26.47 mm |
| Specimen 5 | truncated cone | 1 mm | 26.5 mm | |
| Specimen 6 | truncated cone | 1 mm | 26.2 mm | |

In specimens 1 through 3, the shape of the punch was a hemispherical head, and an average maximum drawing height of 46.96 mm was obtained.

In specimens 4 through 6, the shape of the punch was a truncated cone head, and since breaking occurred at the border between the flat head and the conical surface, the maximum drawing height was only 26.47 mm (average value).

Next, the perforated sheet was put in a press machine to find the maximum drawing height.

Perforated sheet:
Thickness: 1.0 mm
Hole diameter: 3 mm
Hole pitch: 5 mm
Material: JIS G 3131 SPHD
Number of samples: 6

Measuring drawing height of perforated sheet:
The drawing height at the moment tearing occurred was set as the “maximum drawing height.” The maximum drawing height levels found for the six samples are shown in Table 2 below.

TABLE 2

| | | Thickness of | Maximum |
|---|---|---|---|
| Specimen no. | Shape of punch | perforated sheet | drawing height |
| Specimen 7 | hemispherical | 1 mm | 23.5 mm |
| Specimen 8 | hemispherical | 1 mm | 23.7 mm |
| Specimen 9 | hemispherical | 1 mm | 24.3 mm |
| Specimen 10 | truncated cone | 1 mm | 16.0 mm |
| Specimen 11 | truncated cone | 1 mm | 16.0 mm |
| Specimen 12 | truncated cone | 1 mm | 15.9 mm |

In specimens 7 through 9, the shape of the punch was a hemispherical head, and the maximum drawing height was 23.5 to 24.3 mm.

In specimens 10 through 12, the shape of the punch was a truncated cone head, and since breaking occurred at the border between the flat head and the conical surface, the maximum drawing height was only 15.9 to 16.0 mm.

The maximum drawing height levels in the above tables were graphed for samples 1, 2, 3 and samples 7, 8, 9, for which the shape of the punch was a hemispherical head.

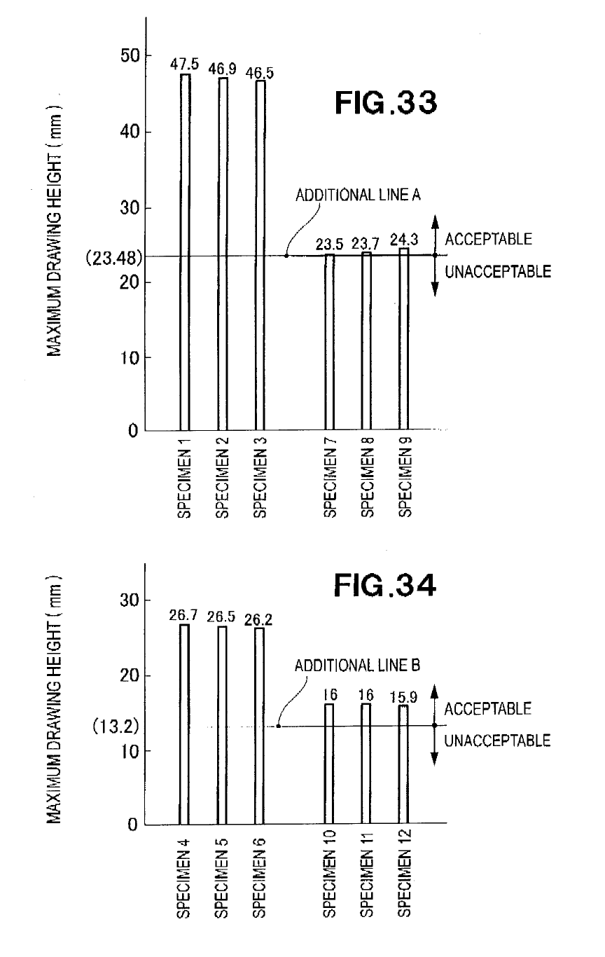

Since the average value of specimens 1, 2, 3 was 46.96 mm, a value equal to half of this average (23.48 mm) was added to the graph, as shown in FIG. 33. The added line is referred to as additional line A.

Specimens 7 through 9 rise above this additional line A. The greater the drawing height, the greater the possible extent of drawing, and above the additional line A is therefore denoted as “acceptable.”

In other words, in cases in which drawing is performed with the drawing height limit set to 23.48 mm, there is no need for concern over tearing in specimens 7 through 9.

Next, the maximum drawing height levels in the above tables were graphed for samples 4, 5, 6 and samples 10, 11, 12, for which the shape of the punch was a truncated conical head.

Since the average value of specimens 4, 5, 6 was 26.47 mm, a value equal to half of this average (13.2 mm) was added to the graph, as shown in FIG. 34. The added line is referred to as additional line B.

Specimens 10 through 12 rise above this additional line B. The greater the drawing height, the greater the possible extent of drawing, and above the additional line B is therefore denoted as “acceptable.”

In other words, in cases in which drawing is performed with the drawing height limit set to 13.2 mm, there is no need for concern over tearing in specimens 10 through 12.

The test results are not shown, but upon performing the same test while varying the hole diameter from 1 to 5 mm, the pitch from 3 to 8 mm (increasing in proportion to the hole diameter), and the thickness from 0.5 to 1.5 mm, the same results as in FIG. 33 and FIG. 34 were obtained.

The drawing height was described above, but when discussing formability with a press, the shape conditions (curve radius, angle of inclined surface, and the like) must also be examined. A work hardening coefficient (hereinbelow referred as the n value) is suitable for this examination.

Specifically, the n value is the value of n in the relational expression σ=Kεⁿ when an actual stress—logarithmic strain curve approaches an exponential function. This value is one indicator expressing drawing formability, and it is widely known that the greater the n value, the more effective it is for drawing formation.

The details are omitted, but the n value of specimen 7 (perforated sheet) was 0.85 times the n value of specimen 1 (mild steel sheet). Specifically, the drawing formability of the perforated sheet is less than the drawing formability of the mild steel sheet. The result is that when the shape conditions of the mild steel sheet are applied to the perforated sheet, there is a possibility that tearing will occur in the perforated sheet. Therefore, the shape conditions of the mild steel sheet (curve radius, angle of inclined surface, and the like) cannot be applied to the perforated sheet.

The appropriate shape conditions for the perforated sheet must be found.

The inventors have examined various types of steel and have determined that the shape conditions of high-tensile steel can be applied. The reasons for this will next be described.

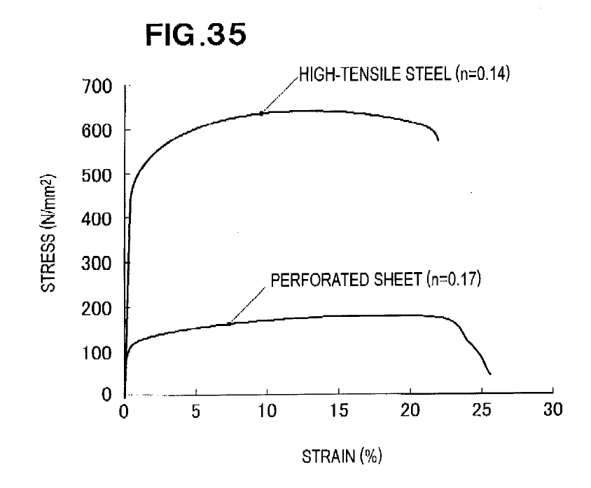

The indicator (the n value in σ=K₁·εⁿ) of the plastic region in the perforated sheet was found to be approximately 0.17, as shown by the strain-stress graph in FIG. 35.

Upon finding the relationship between stress and strain in a high-tensile steel sheet (JIS G 3135 SPFC590) that had not undergone punching, the indicator (the n value in σ=K₂·εⁿ) of the plastic region in the curve was found to be approximately 0.14.

As described above, the greater the n value, the better the drawing formability, and tearing does not readily occur when plastic forming is performed.

The n value of the perforated sheet (approximately 0.17) is about 20% greater than the n value of the high-tensile steel sheet (approximately 0.14). There is no need for concern over the perforated sheet tearing even if plastic working is performed based on the shape conditions of this type of high-tensile steel sheet.

Data on the shape conditions (curve radius, angle of inclination, and the like) of high-tensile steel sheets (sheets with no holes) has been accumulated in abundance with a recent increased demand for high-tensile steel sheets.

Since it is possible with the present invention to skillfully use the easily acquirable shape conditions of a high-tensile steel sheet to perform plastic working on a perforated sheet, the working shape can be easily determined when drawing a perforated sheet.

Because of the foregoing knowledge, a perforated sheet working method, for punching a mild steel blank material and the resulting perforated sheet is further subjected to drawing, includes the steps of setting drawing height conditions within a range that does not exceed 50% of the drawing height limit of the mild steel blank material; setting, as shape conditions, the limit of the extent of bending, the limit of the angle of the inclined surface, and other limit conditions taken into account when drawing the high-tensile steel sheet; and performing drawing on the basis of the shape conditions and the drawing height conditions.

Since the conditions to work the perforated sheet can be established based on the blank material and the high-tensile steel sheet, the conditions to work the perforated sheet can be established easily.

The press machine 60 may be either a hydraulic press or a mechanical press. Instead of a system for lowering the punch, the press machine may be a system for raising the punch, or a punchless bulging (protruding, swelling) apparatus.

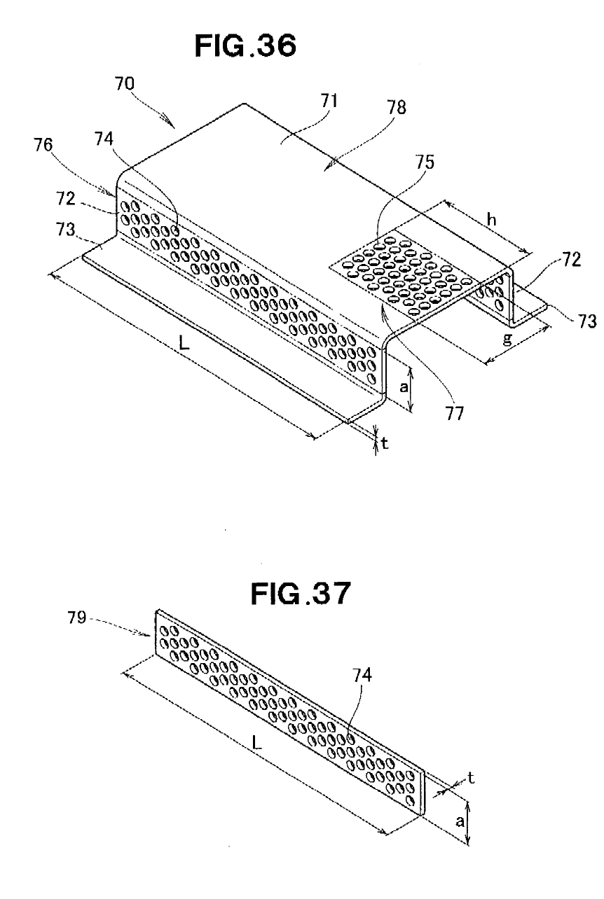

An example of a plastic-worked perforated sheet is a three-dimensional shaped sheet such as is shown in FIG. 36.

A twelfth model 70 shown in FIG. 36 is a groove-shaped perforated sheet obtained by folding a metal sheet having a thin thickness t, and is composed of, e.g., a wide flat sheet part 71, vertical wall parts 72, 72 that extend down from the ends of the flat sheet part 71, and protruding parts 73, 73 that both extend outward parallel to the flat sheet part 71 from the bottom ends of the vertical wall parts 72, 72; wherein holes 74 are provided in a belt formation to the vertical wall parts 72, 72, and holes 75 are also provided to the flat sheet part 71 so as to form a rectangular shape.

The rectangular portions in which the large number of holes 74 are formed are hole formation areas 76 having a width of a and a length of L.

The rectangular portion in which the large number of holes 75 are formed is a hole formation area 77 having a width of g and a length of h.

The portion excluding the hole formation areas 76 and the hole formation area 77 is referred to as the remaining area 78. No holes are formed in the remaining area 78.

Next, a test piece 79 is created, having a width of a and a length of L as shown in FIG. 37. This test piece 79 is equivalent to a hole formation area 76 whose width is a, whose length is L, and whose thickness is t.

Young's modulus is also referred to as the longitudinal elastic modulus, and is one physical value representing the durability of a structure. Young's modulus is a characteristic value determined by material and temperature.

Young's modulus can be measured by static testing, by lateral vibration, or by ultrasonic waves.

The most common method of static testing is described in the next diagram, but methods of lateral vibration or ultrasonic waves may also be used.

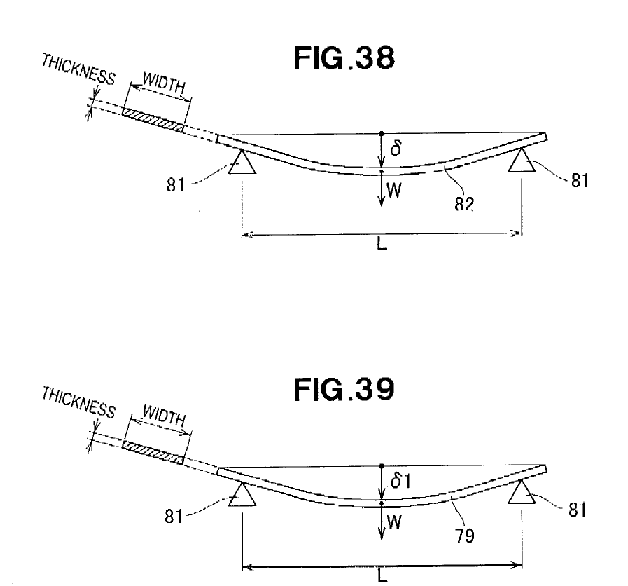

A beam 82 is placed on two fulcra 81, 81, and a downward load W is applied in the center as shown in FIG. 38. At this time, the center flexes by an amount δ. The following formulas are established through structural mechanics.

δ=W·L³/(48·E·I) (1)

I=(width)·(thickness)³/64 (2)

E=W·L³/(48·δ·I) (3)

In Formula (1), δ denotes flexure, W denotes load, L denotes the distance between the fulcra, E denotes Young's modulus, and I denotes the geometrical moment of inertia. The beam 82 is a member having a uniform cross section and no holes.

The geometrical moment of inertia I is given by Formula (2). The width is a shown in FIG. 36, and the thickness is t shown in FIG. 36. When Formula (1) is modified in terms of E, Formula (3) is the result.

Next, the beam 82 is replaced with the test piece 79 as shown in FIG. 39. When the load W is applied to the center, the flexure is δ1. The apparent Young's modulus is then found through the following Formula (4).

E1*=W·L³/(48·δ1·I) (4)

An object having no holes is used for the geometrical moment of inertia I. W, L, the material, and the surrounding temperature are the same as in FIG. 38. Since the Young's modulus depends on the material and the temperature, the Young's modulus of the beam 82 and the Young's modulus of the test piece 79 are the same.

However, the test piece 79 provided with holes flexes by a greater amount than the beam 82 in which no holes have been made. Specifically, δ<δ1 and E1*<E.

In view of this, E1* is referred to as the “apparent Young's modulus,” and is distinguished from the “Young's modulus.”

The thickness t of the test piece 79 (FIG. 37) is 1.6 mm, the width a is 23 mm, and the length L is 200 mm. 3 mm edges are placed at the top and bottom, and the remaining 17 mm (=23−3×2) is provided with holes 3 mm in diameter at a pitch of 5 mm so that the aperture ratio (total area of holes/hole-less sheet) is 32%. The material is steel.

The apparent Young's modulus found through the aforementioned measurements was 120 GPa in the test piece 79 described above. Since the Young's modulus of mild steel at room temperature is 206 GPa, the apparent Young's modulus in this example is approximately 60% of the Young's modulus.

Next, the apparent Young's modulus of the test piece 79 in FIG. 37 is found through calculation. The calculation is made through the finite element method or another such method of analysis. For example, in the finite element method, a frame is partitioned into a mesh shape and numerous elements are set. The elements are smaller than the diameter of the holes.

The apparent Young's modulus found by calculation with the finite element method was 122 GPa.

122 GPa is substantially the same as the 120 GPa found through actual measurement, and the two are a satisfactorily match. In other words, the validity of the calculated value was confirmed, and it was confirmed that the calculated value may be used for the apparent Young's modulus of the test piece 79.

In view of this, the apparent Young's modulus of the hole formation area 77 having a width of g and a length of h shown in FIG. 36 is also calculated by the finite element method.

The apparent Young's modulus of the hole formation areas 76 having a width of a and a length of L was 120 GPa, and the apparent Young's modulus of the hole formation area 77 having a width of g and a length of h was 108 GPa. The Young's modulus of the remaining area is 206 GPa, and this value does not need to be calculated and can be determined from the material and other conditions.

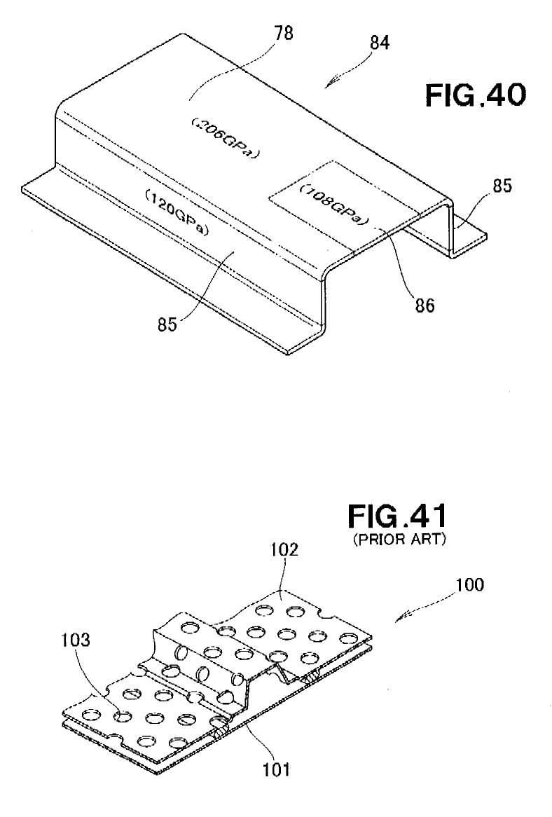

Next, an assembly 84 shown in FIG. 40 is presented. The assembly 84 is a perforated sheet composed of solid areas 85 obtained by removing all of the holes 74 from the hole formation areas 76 shown in FIG. 36, a solid area 86 obtained by removing all of the holes 75 from the hole formation area 77 shown in FIG. 36, and a remaining area 78. An apparent Young's modulus of 120 GPa is applied to the solid areas 85, an apparent Young's modulus of 108 GPa is applied to the solid area 86, and a Young's modulus of 206 GPa is applied to the remaining area 78.

Moreover, mechanical characteristics of the assembly 84 are calculated. No holes are formed in the assembly 84. Since no holes are formed, the elements can be enlarged. As a result, there are fewer partitions, and it is possible to easily calculate flexure, bending stress, torsional stress, tensile stress, compressive stress, and other mechanical characteristics.

Specifically, the present invention is a method for estimating the mechanical characteristics of a perforated sheet partitioned into hole formation areas in which holes are formed in regular order, and a remaining area in which holes are not formed, wherein there is a plurality of hole formation areas, and the hole formation areas have rectangular shapes;

the method comprising the steps of creating a test piece having the same shape as the hole formation areas, obtaining actual measurement values related to mechanical characteristics by performing tests on the test piece, obtaining calculated values related to mechanical characteristics by performing calculations on the test piece, obtaining specialized calculated values related to mechanical characteristics by performing calculations on the hole formation areas upon confirmation that the difference between the actual measurement values and the calculated values is less than a specified value, assembling solid areas, which are obtained by not forming any holes in the usual hole formation areas, on the remaining area, and applying the specialized calculated values to the solid areas in the resulting assembly; wherein calculations for the strength of the perforated sheet can be performed with the assembly in which holes are not formed.

Next, when the difference between the calculated values and the actual measurement values is equal to or greater than specified values (e.g., 5%) in the step (stage) for confirming the validity of the calculated values, the following process is preferably performed.

The apparent Young's modulus obtained from actual measurement values and the apparent Young's modulus obtained by calculation were the values shown in Table 3 below.

TABLE 3

| | |
|---|---|
| Apparent Young's modulus obtained from | 113 GPa |
| actual measured values | |
| Apparent Young's modulus obtained by | 122 GPa |
| calculation | |

The difference between the values is 8%, according to the calculation (122−113)/113=0.08.

In this case, a correction value was determined based on the equality: (apparent Young's modulus obtained from actual measurement values)/(apparent Young's modulus obtained by calculation)=correction value. In the present example, the correction value was 0.93, according to the calculation 113/122=0.93.

If the apparent Young's modulus values obtained by calculation with material thicknesses of 23 mm, 73 mm, and 109 mm are the values shown in Table 4 below, the corrected apparent Young's modulus can be easily found by multiplying these values with the correction value (0.93).

TABLE 4

| | Material width | | |
|---|---|---|---|
| | 23 mm | 73 mm | 109 mm |
| Apparent Young's | 122 GPa | 103 GPa | 100 GPa |
| modulus obtained by | | | |
| calculation | | | |
| Correction coefficient | 0.93 | 0.93 | 0.93 |
| Corrected apparent | 113 GPa | 96 GPa | 93 GPa |
| Young's modulus | | | |

The method for estimating the mechanical characteristics of the present invention is suitable for examining the mechanical characteristics of structural members of a vehicle, but the method may also be applied to calculating the mechanical characteristics of a perforated sheet applied in a common structure.

Obviously, various minor changes and modifications of the present invention are possible in light of the above teaching. It is therefore to be understood that within the scope of the appended claims the invention may be practices otherwise than as specifically described.

1. A perforated sheet obtained by forming holes in regular order in a metal sheet, wherein hole groups in even-numbered rows are arranged misaligned from hole groups in odd-numbered rows by a pitch of 0.5 in a direction of the rows, and tension is applied through external force in a direction orthogonal to the rows;
a (1-1) hole which is a first hole in a first hole group, a (1-2) hole which is a next hole after the (1-1) hole, and a (2-1) hole which is a first hole of a second hole group are disposed at apexes of a triangle;
a tangential line that extends in a tensile direction while being tangent to a top edge of the (2-1) hole either passes between a tangential line that extends in the tensile direction while being tangent to a bottom edge of the (1-1) hole and a tangential line that extends in the tensile direction while being tangent to a top edge of the (1-2) hole, or passes above the tangential line that extends in the tensile direction while being tangent to the bottom edge of the (1-1) hole; and
a tangential line that extends in the tensile direction while being tangent to the bottom edge of the (2-1) hole either passes between a tangential line that extends in the tensile direction while being tangent to the bottom edge of the (1-1) hole and a tangential line that extends in the tensile direction while being tangent to the top edge of the (1-2) hole, or passes above a tangential line that extends in the tensile direction while being tangent to the top edge of the (1-2) hole.

2. A perforated sheet obtained by forming holes in regular order in a metal sheet subjected to tension in a longitudinal direction,
wherein the holes are oblong holes extending in the longitudinal direction.

3. The perforated sheet of claim 2, wherein the oblong holes have a major axis 2.0 to 5.0 times a minor axis in length.

4. The perforated sheet of claim 2, comprising a flat sheet part provided with the oblong holes, and wall parts that extend downward from ends of the flat sheet part and do not have oblong holes, the perforated sheet having a shape of a channel.

5. A method for selecting a hole shape for a perforated sheet obtained by forming oblong holes or round holes in regular order in a metal sheet, wherein
in cases in which flexural rigidity is required and an acting direction of a force for bending the metal sheet can be designated, oblong holes are selected as the holes, and the oblong holes extend along lines whereby fulcra that support the metal sheet are joined with a load point of action of the bending force;
in cases in which tensile strength is required and a direction in which tension acts on the metal sheet can be designated, oblong holes are selected as the holes, and the oblong holes are extended along a tensile direction and arranged at points of intersection in a lattice; and
in cases in which tensile strength is required and the direction in which tension acts on the metal sheet cannot be designated, round holes are selected as the holes, and the round holes are arranged at points of intersection of a lattice.

6. A perforated sheet working method for punching a mild steel blank material and then drawing the resulting perforated sheet; the method comprising the steps of:
setting drawing height conditions within a range that does not exceed 50% of a drawing height limit of the mild steel blank material;
setting, as shape conditions, a limit of an extent of bending, a limit of an angle of an inclined surface, and other limit conditions taken into account when drawing a high-tensile steel sheet; and
performing drawing on a basis of the shape conditions and the drawing height conditions.

7. A method for estimating the mechanical characteristics of a perforated sheet partitioned into hole formation areas in which holes are formed in regular order, and a remaining area in which holes are not formed, wherein there is a plurality of hole formation areas, and the hole formation areas have rectangular shapes, the method comprising the steps of:
creating a test piece having a same shape as the hole formation areas;
obtaining actual measurement values related to mechanical characteristics by performing tests on the test piece;
obtaining calculated values related to mechanical characteristics by performing calculations on the test piece;
obtaining specialized calculated values related to mechanical characteristics by performing calculations on the hole formation areas upon confirmation that a difference between the actual measurement values and the calculated values is less than a specified value;
assembling solid areas, which are obtained by not forming any holes in usual hole formation areas, on the remaining area; and
applying the specialized calculated values to the solid areas in the resulting assembly, so that calculations for strength of the perforated sheet are performed with the assembly in which holes are not formed.

8. The method of claim 7, wherein when the difference between the actual measurement values and the calculated values is equal to or greater than a predetermined value, a correction value is determined based on the difference, and the calculated values are corrected using the correction value.
